(19) United States
(12) Patent Application Publication
(10) Pub. No.: US 2026/0151938 A1
(43) Pub. Date: Jun. 4, 2026

(54) METHOD AND APPARATUS FOR RECYCLING COMPOSITE MILL LINERS

(71) Applicant: FLSmidth A/S, Valby (DK)

(72) Inventors: Peter Sommer Larsen, TAASTRUP (DK); SOREN BASTHOLM VENDELBO, COPENHAGEN (DK); RAJEESH RAGHUNATHAN, CHENNAI (IN); SHANMUGAM PERUMAL, CHENNAI (IN)

(21) Appl. No.: 19/125,237

(22) PCT Filed: Sep. 1, 2023
(86) PCT No.: PCT/IB2023/058659

§ 371 Date: Apr. 28, 2025

(30) Foreign Application Priority Data
Oct. 28, 2022 (IN) 202241061439

(51) Int. Cl. B29B 17/02; B29B 17/00; B29B 17/04

(52) U.S. Cl. CPC B29B 17/021; B29B 17/04; B29B 2017/0094; B29B 2017/0268; B29B 2017/0496

(57) ABSTRACT

The present invention relates to method and apparatus for recycling composite mill liners. This invention is preferably concerned with an optimized method of recycling worn out composite mill liners by effectively disassembling the composite into metal and rubber parts that can be reused, as well as a mobile apparatus for carrying out the method.

### FIELD OF INVENTION

The present invention relates to method and apparatus for recycling composite mill liners. This invention is preferably concerned with an optimized method of recycling worn out composite mill liners by effectively disassembling the composite into metal and rubber parts that can be reused, as well as a mobile apparatus for carrying out the method.

### BACKGROUND

Composite mill liners are high-performance lightweight mill liners uniquely constructed with rubber and metal inserts. It combines the benefits of steel liners with the flexibility of rubber liners. Every grinding mill lining application has different characteristics that require unique composite mill liner that has better mill performance and longer liner life. Used miller liners are heavy structures weighing between 1 and 4 tons. Currently, used/worn out mill liners are disposed to landfills and it constitute one important part of solid waste. Both the metal part and the rubber have good recycling value as recycled material and some part of the metal, in particular the base plate which is not worn out during the operation of the mills, has high reuse value. However, due to inherent nature of heterogeneity, in particular, different characteristics for different liners, recycling mill liners have been a huge challenge till date. To achieve the current objective of sustainability in mining and cement engineering, recovering and recycling end-of-life products, like mill liner, are essential. Recycling will ultimately lead to resource and energy saving.

So far, no commercial technology for successful large-scale recycling of composite mill liners has been reported. Lack of adequate equipment, high recycling cost, and lower quality of the recyclates could be the major commercialization barriers. To promote composites recycling, extensive R&D efforts are still needed on development of ground-breaking better recyclable composites and much more efficient separation technologies.

Whereas recycling tires made of composite materials have been discussed in patent publications. In particular, in the field of the processing and recovering of tires, mainly waste tires, widely used conventional methods are to burn the rubber part in an incinerator and collet the core metal remaining after incineration; or to mechanically pull metal wires from the rubber and cut the rubber part up for recycling.

CN201721031959 provides a technical solution for recycling tires by increasing the temperature of the wire portion of the rubber by passing an electric current therein which separates the wire portion from the rubber portion. The disadvantage of this solution is for each scrap tire to be treated, the electrodes are connected to both ends of the steel wire in the tire, and the operation steps are numerous, which is not favorable for the large-scale treatment of the waste tire.

U.S. Pat. No. 6,979,384, proposes induction heating of waste tires. The waste casing of the tire is first divided into tread ring, sidewalls and bead portions. The tread ring is then guided on the outside (with the tread pattern) on a rotating guide drum around the inductor. Thus, the metal reinforcement wires are gradually inductively heated, the rubber in the vicinity degrades to form gaseous products, and the metal reinforcement is then gradually released on the curved guide drum and separated from the rubber part. The main problem here is the uneven heating of the metal reinforcement due to the fact that the tread ring passes under the inductor only one side and the fact that the high frequency field with constant intensity given by the inductor arrangement cannot ensure even induction heating of the metal reinforcement over the entire width of the strip. The edge parts of the reinforcement are heated less, which is of course reflected in the quality of the separation of the composite layers.

US 2004/0173699 A1 intends to provide a tire recycling method and apparatus capable of simply and rapidly treating waste tires and obtaining cut rubber pieces which can be reused as useful rubber materials. The method and the apparatus comprise cutting the circumferential surface of the tire to a predetermined depth by a rotary cylinder having cutting blades each of a rhombic flat plate shape and subsequent separation of metal reinforcement components embedding the tire from the rubber component by RF induction heating that decomposes and carbonizes the rubber portion adjacent with the heated metal components. Cutting by the rhombic blades in the essential part of this disclosure that enables smooth and effective removal of surface tire layer, facilitating the succeeding RF heating and yielding useful cut rubber suitable to obtain variable recycle materials.

The methods and apparatus as discussed in the above prior art documents have several substantial disadvantages for application in mill liners. The basic disadvantage is that the mill liners are heavy structures with larger metal reinforcement and metal base plates. Said methods and apparatus are only suitable, thus, for recovery of whole tires and the thin metal wires embedded in the tire. Yet another disadvantage is that the induction heating coil is located around the radial outer circumference of the tire such that it is close to the surface layer of the tire, which arrangement cannot ensure even induction heating of the metal reinforcement of the mill liner over its entire width.

Accordingly, it is an object of the present invention to provide a method for the disassembling of metal and rubber part from the composite mill liners, mainly used/worn out mill liners, which method, owing to both simplicity and versatility thereof, would make it possible to ensure a high capacity of the recovery method thereby the recovery of recyclable parts.

It is also an object of the present invention to provide an apparatus for the recovery of metal and rubber part from the composite mill liners, mainly used/worn out mill liners, which apparatus, owing to both simplicity and versatility thereof, would make it possible to ensure a high capacity of the recovery method thereby the recovery of recyclable parts.

### SUMMARY OF THE INVENTION

The object set is achieved in accordance with the present invention, by a method for separation of metal reinforcement from rubber-metal composite of used mill liners comprising:
a) radiating the metal components embedded in the mill liner by gradually passing the composite part, by its length or circumference, more than one time through a high-frequency induction field and drawing different metal components out of the composite mill liner after each pass, wherein the induction filed is supplied by a circumventing inductor coil shaped to follow to the geometry of the mill liner's cross section to be recycled and supplies up to 1,000 kW/m² to parts of the metal surface for induction heating of the metal reinforcement over the entire width of the composite material, sufficient to pyrolyze a thin rubber layer in contact with the metal surface, thereby releasing the metal from the rubber matrix;
b) separating the metal part from the rubber portion of the composite material involving a secondary mechanical separation to draw the metal component out of the composite mill liner.

The method according to the present invention wherein radiating the metal component embedded in the mill liner heats the metal surface to a temperature between 450° C. to 650° C., preferably between 500° C. to 600° C., most preferably between 500° C. to 550° C., whereby a thin layer of primer, binder and rubber on the steel surface is pyrolyzed into gasses, fumes and solid carbon rich compounds such as coke, charcoal and graphite.

The method according to the present invention, further comprising controlling the speed of induction heating in order to minimize degradation of both rubber and metal to maintain optimal properties for recycling of materials or refurbishment of metal components.

The method according to the present invention, wherein the speed of heating is controlled by the speed at which the composite mill liner is fed through the induction field.

The method according to the present invention, wherein the speed of heating is controlled by changing the power of the induction field such that different parts of the metal components are heated at different rates while passing through the induction field.

The method according to the present invention, wherein the speed of heating is controlled by the geometry of the inductor coil to focus the induction field at certain parts of the metal components while they passe through the induction field.

The method according to the present invention, wherein the speed of heating is controlled by external magnetic materials to focus the induction field on certain parts of the metal components while they passe through the induction field.

The method according to the present invention, wherein the speed of heating is controlled by any combination of said methods to control the speed of heating.

The method according to the present invention, wherein the step of separating the metal component from the rubber portion involving secondary mechanical separation includes vibrating, shaking, milling, dropping, hammering, pushing or pulling operations.

The method according to the present invention, wherein it further comprises step for sorting rubber and metal components after induction heating.

The method according to the present invention, wherein a further step for sorting rubber and metal components after induction heating comprising cutting, shredding, and filtering operations.

The method according to the present invention, wherein a further step for sorting rubber and metal components after induction heating comprises gravitational separation.

The method according to the present invention, wherein a further step for sorting rubber and metal components after induction heating comprises magnetic separation.

The method according to the present wherein a further step for sorting rubber and metal components after induction heating combines any of said methods for sorting rubber and metal.

The method according to the present invention, wherein it further comprises the step for avoiding fumes, off-gasses and coal particles generated during induction heating.

The method according to the present invention, wherein a further step for avoiding fumes, off-gasses and coal particles generated during induction heating comprising a ventilation in form of a suction above the heating zone.

The method according to the present invention, wherein a further step for avoiding fumes, off-gasses and coal particles generated during induction heating comprises an air blower, e.g. a fan or a centrifugal blower, placed such that fumes, off-gasses and coal particles are blown away from the heating zone.

The method according to the present invention, wherein a further step for avoiding fumes, off-gasses and coal particles generated during induction heating comprises a shielding or a cabinet directing an air stream such that fumes, off-gasses and coal particles are removed from the heating zone.

The method according to the present invention, wherein a further step for avoiding fumes, off-gasses and coal particles generated during induction heating combines said methods to avoid fumes, off-gasses and coal particles.

The method according to the present invention, wherein a further step for avoiding fumes, off-gasses and coal particles generated during induction heating lowers concentration of ignitable components in a region with temperatures above the flash point below a critical ignition limit described by a Lower Explosion Level (LEL for gases and vapors) or a Minimum Explosible Concentration (MEC for powders).

The method according to the present invention, wherein a further step for avoiding fumes, off-gasses and coal particles generated during induction heating comprises using a non-oxidizing gas stream to displace oxygen in the heating zone.

The method according to the present invention, wherein a further step for avoiding fumes, off-gasses and coal particles generated during induction heating comprises a filtering unit filtering particles from the exhaustion air or gas stream to avoid their leakage into the open.

The method according to the present invention, further comprising extinguishing fire caused by fumes, off-gasses, coal particles generated during induction heating, or by the rubber parts themselves, by using a manual or semi-automatic or automatic fire suppression system above the heating zone and optionally extending partly or fully over the liner's path such that fires that persists on either side of the heating zone may still be extinguished.

The method according to the present invention, wherein the manual, semi-automatic, or automatic fire suppression system consists of a carbon dioxide or other oxygen displacement gas extinguishing system.

The method according to the present invention, wherein a said manual or semi-automatic or automatic fire suppression system consists of a water mist extinguishing system.

The method according to the present invention, wherein a said manual or semi-automatic or automatic fire suppression system is coupled to a power safety break or other close down control for the full apparatus.

The method according to the present invention, wherein a said manual or semi-automatic or automatic fire suppression system is coupled gas sensors and alarms and operator's safety alarms.

The method according to the present invention, wherein the metal component of the composite mill liner has magnetic or electric properties.

The method according to the present invention, further comprising controlling magnetic flux penetration into the composite part by the use of a magnetic shielding around the inductor or placing permanent magnets around the inductor or using a soft magnetic material comprising magnetic particles, e.g., ferrite particles in a polymeric matrix formed to shape around the inductor.

In another embodiment, the present invention also relates to an apparatus for separation of metal reinforcement from rubber-metal composite of used mill liners and a mill liner positioned within the apparatus for separation of metal reinforcement and rubber-metal composite, wherein it comprises:
a) an induction system comprising a circumventing inductor coil shaped to follow to the geometry of the mill liner's cross-section, positioned within the apparatus, and supplying up to 1,000 kW/m² on parts of the metal surface for induction heating of the metal reinforcement over the entire width of the composite material, sufficient to pyrolyze a thin rubber layer in contact with the metal surface and efficiently separate the metal parts from the composite mill liner;
b) an automatic conveyor system for transporting the mill liner through the inductor; and
c) a secondary mechanical separation system for separating the metal part from the rubber portion of the composite mill liner.

The apparatus according to the present invention, wherein it further comprises
d) an induction heating generator, capable of outputting power of 35 to 200 kW for induction heating of the metal reinforcement over the entire width of the composite material; and
e) a cooling system capable of cooling both power supply and the inductor with safety interlocks and differential pressure monitoring for automatic lockdown of the induction heating supply.

The apparatus according to the present invention, wherein the induction system further comprises any of the following:
i) ventilation system consisting of a ventilator and a shield allowing for a air flow of sufficient strength to flow around the section of the mill liner that is closest to the inductor to lower fume concentration below ATEX limits; Where close means the width of the inductor+100 mm on both sides of the inductor.
ii) magnetic shielding for lowering flux outside the induction system to zero;
iii) control unit for controlling the speed of the mill liner part moving through the induction system;
iv) focusing system that positions the mill liner part for passing through the induction system, which is adaptable to different liner geometries.

The apparatus according to the present invention, wherein the ventilation system additionally comprises centrifugal fan capable of blowing off gasses and fumes away from the heated areas to avoid ignition.

The apparatus according to the present invention, wherein the ventilation system can remove off gasses, dust and fumes generated with a rate of 5-10 g/s, 10-25 g/s from the heated areas to avoid ignition.

The apparatus according to the present invention, wherein the ventilation system can secure an air exchange of 1000-30,000 m³/hour around the section of the mill liner closest to the inductor.

The apparatus according to the present invention wherein the inductor can achieve an energy transfer sufficient to raise the surface temperature of steel parts to between 500° C. to 550° C., preferably 500° C. to 600° C.; most preferably 500° C. to 650° C. whereby a thin layer of primer, binder and rubber on the steel surface is pyrolyzed into gasses, fumes and solid carbon rich compounds like coke, charcoal and graphite.

The apparatus according to the present invention wherein the inductor is made from highly conductive rectangular copper bars or pipe (99% purity or better). The coil shall be flexible enough to accommodate slight bending so that small errors in curvatures can be corrected. The coil cross section and number of turns are optimized to fit power and frequency limits of the induction heating power supply and load circuitry while maximizing energy transfer to the composite mill liner's steel parts.

The apparatus according to the present invention wherein the inductor is shaped to follow the geometry of the composite liner's cross section.

The apparatus according to the present invention wherein the circumventing inductor coil, shaped to follow to the geometry of the composite liner's cross section, optionally comprises protrusions at sharp corners to reduce uneven heating.

The apparatus according to the present invention wherein the inductor comprises a casing in the form of a metallic shield or any other form that withstands temperature from 300° C. to 650° C. and allows for controlling magnetic flux penetration into the article.

The apparatus according to the present invention wherein the inductor comprises a casing in the form of a metallic shield or any other form that withstands temperature from 300° C. to 650° C. and allows for controlling and minimizing magnetic flux penetration outside the article.

The apparatus according to the present invention wherein the inductor is fixed by a non-metallic casing where permanent magnets or high magnetic permeability parts are distributed in the casing, particularly, highly conducting particles are distributed in or around the casing in order to control the magnetic flux penetration into the article.

The apparatus according to the present invention wherein the inductor is fixed by a non-metallic casing where parts of the non-metallic material is filled with ferrite or other magnetic particles or other shapes of fillers.

The apparatus according to the present invention wherein said non-magnetic material is a high temperature resistant thermoplastic or thermoset.

The apparatus according to the present invention wherein said non-magnetic material is a high temperature resistant thermoplastic or thermoset shaped to imbed the inductor by molding, other plastic processing or toolwork technologies.

The apparatus according to the present invention wherein said non-metallic casing is a high temperature resistant thermoplastic selected from one or more of PEEK, PSS, PSU, flour polymers, PBI, polyimide, polyamides, polyaramides or other high temperature resistant thermoplastics.

The apparatus according to the present invention wherein said high temperature resistant thermoplastic material is a composite with a non-metallic filler or a metallic filler with size less than a critical eddy current limit.

The apparatus according to the present invention wherein said non-metallic casing is a high temperature resistant thermoset selected from one or more of silicones, modified-silicones, epoxy thermosets, polyurethanes or other high temperature resistant thermosets curable by any means including heat, light or chemical agents.

The apparatus according to the present invention wherein said high temperature resistant thermoset material is a composite with a non-metallic filler or a metallic filler with size less than a critical eddy current limit.

The apparatus according to the present invention wherein said non-magnetic material is wood or a wood composite shaped to imbed the inductor by forming or toolwork technologies.

The apparatus according to the present invention wherein said non-magnetic material is a ceramic material shaped to imbed the inductor by a forming, toolwork or moulding technology.

The apparatus according to the present invention wherein said non-magnetic material is a refractory material shaped to protect machinery parts and the environment from the heat.

The apparatus according to the present invention wherein the secondary mechanical separation system comprises cranes or grabbers capable of lifting or shaking metal and rubber parts apart subsequent to induction heating of the metal part.

The apparatus according to the present invention wherein the secondary mechanical separation system comprises a shaker machinery capable of shaking metal and rubber parts apart subsequent to induction heating of the metal part.

The apparatus according to the present invention wherein the secondary mechanical separation system further comprises vibration filter for filtering and colleting charcoal dust and small rubber particles released from the secondary mechanical separation.

The present invention in an additional embodiment relates to a mobile recycling unit comprising the apparatus as defined above in a container and deliverable to the site of requirement.

The apparatus according to the present invention, wherein it is a mobile unit wherein the apparatus as defined above is contained into a container.

The apparatus according to the present invention, wherein it is a mobile unit wherein the apparatus as defined above is contained into a container and operated while installed in the container.

The apparatus according to the present invention, wherein it is a mobile unit wherein the apparatus as defined above is contained into a container and operated after deployed and installed outside the container.

The apparatus according to the present invention, wherein it is a mobile unit wherein the apparatus as defined above is contained into a container and operated after parts of the apparatus are deployed and installed outside the container, while other parts are operated inside the container.

The apparatus according to the present invention, wherein it is a mobile unit wherein the inductions system, the ventilation, and the fire suppression system is operated while installed in the container.

The apparatus according to the present invention, wherein said container opens in both ends to allow for easy unpacking.

The apparatus according to the present invention, wherein said container opens in both ends and sides for easy access to the induction system, the ventilation, and the fire suppression system installed in the container while operating it.

The apparatus according to the present invention, wherein said container opens in both ends for easy fitting of the liner loading and extraction parts to the induction system, the ventilation, and the fire suppression system installed in the container.

The apparatus according to the present invention, wherein it is a mobile unit wherein the apparatus as defined above is contained into one or more containers.

The apparatus according to the present invention, wherein it is a mobile unit wherein the apparatus as defined above is contained into one or more containers and where one container contains parts that are mounted and operated inside the container, where the remaining parts are fitted to the container parts under deployment.

In another embodiment, the present invention relates to a system comprising an apparatus for separation of metal reinforcement from rubber metal composite of used mill liners and a mill liner positioned within the apparatus for separation of metal reinforcement and rubber-metal composite, wherein the apparatus for separation of metal reinforcement from rubber-metal composite of used mill liners, comprises:
a) an induction system comprising a circumventing inductor coil shaped to follow to the geometry of the mill liner's cross-section, positioned within the apparatus, and supplying up to 1,000 kW/m² on parts of the metal surface for induction heating of the metal reinforcement over the entire width of the composite material, sufficient to pyrolyze a thin rubber layer in contact with the metal surface and efficiently separate the metal parts from the composite mill liner;
b) an automatic conveyor system for transporting the mill liner through the inductor; and
c) a secondary mechanical separation system for separating the metal part from the rubber portion of the composite mill liner.

In another embodiment, the present invention relates to a mobile recycling unit comprising the apparatus according to the present invention contained in one or more container and deliverable to the site of requirement.

### BRIEF DESCRIPTION OF THE DRAWING

A preferred embodiment of this invention will be described in detail based on the drawings, wherein

FIG. 1 is a schematic representation of an embodiment of the apparatus according to the present invention adapted for mobile application. The parts of the figure refer to Table 1.

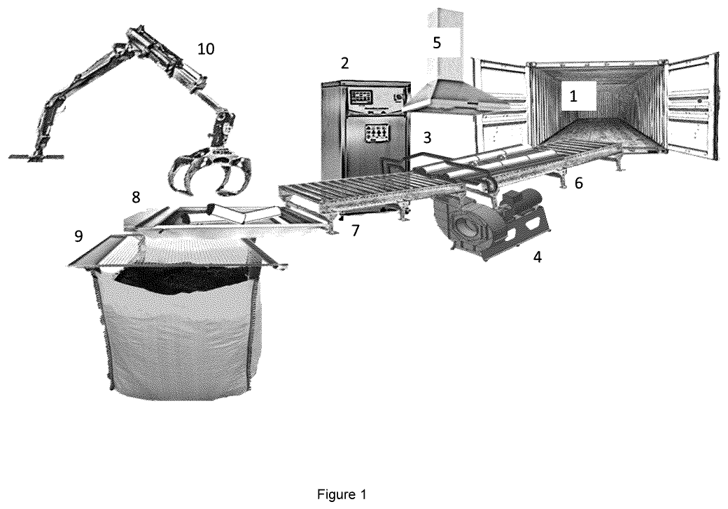

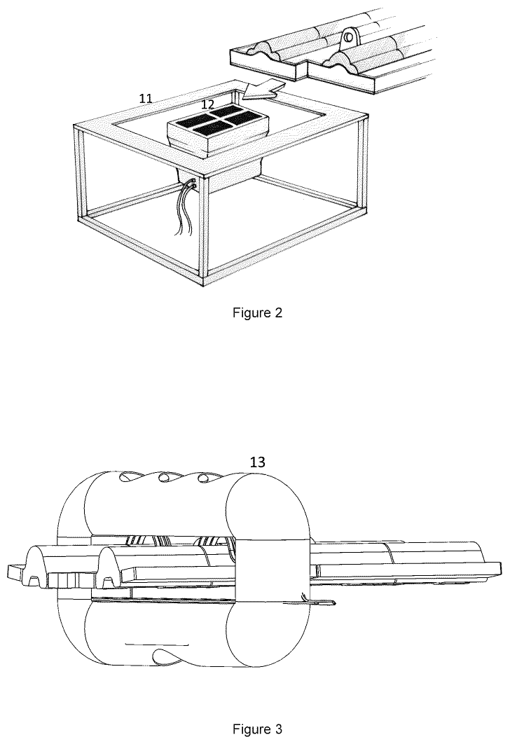

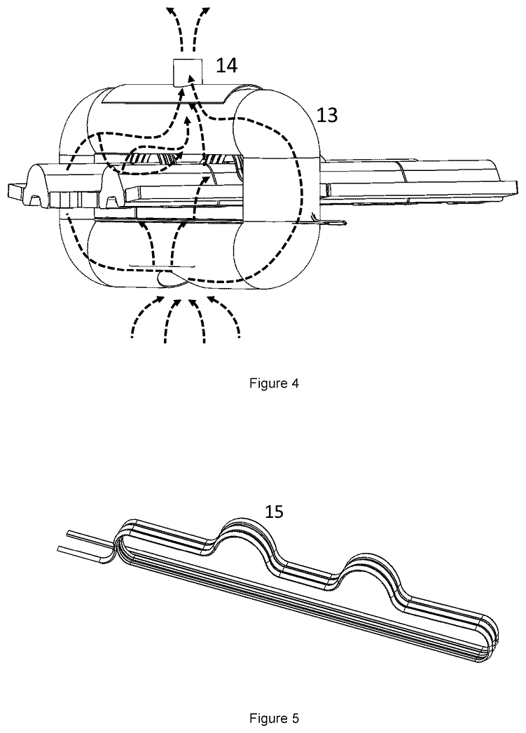

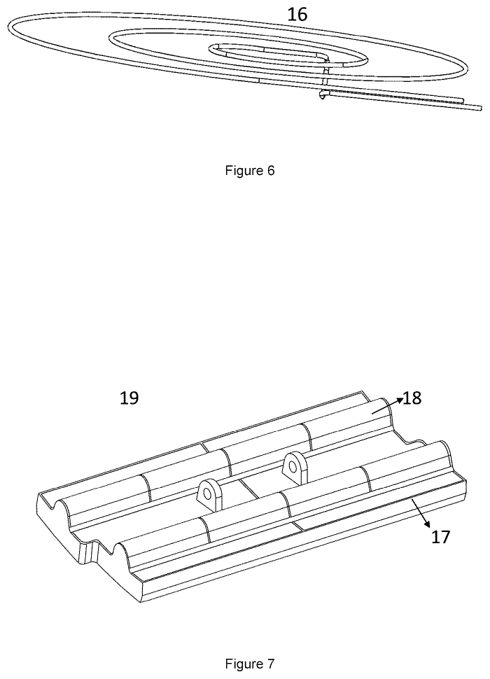

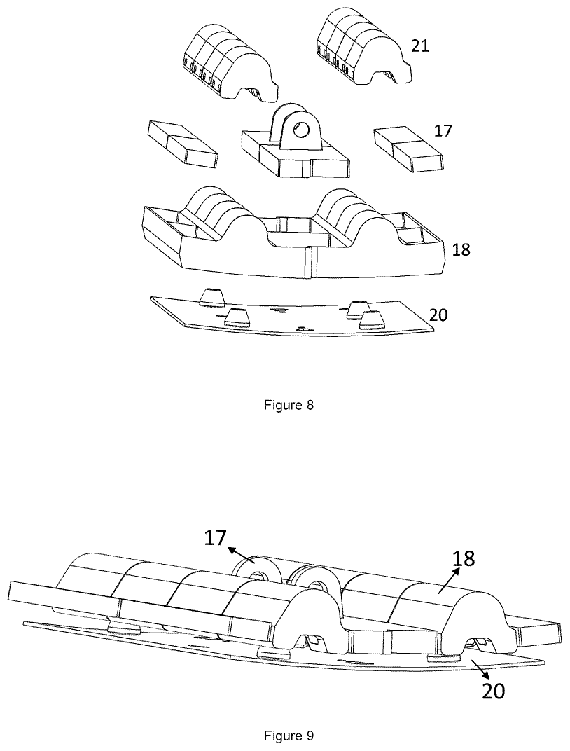

TABLE 1
Numbered parts in FIG. 1.

| System | Component | Number | Description |
|---|---|---|---|
| Container | Container | 1 | |
| Induction | Generator | 2 | Induction heating generator. Several components |
| heating | | | are not shown: |
| | | | Power supply: It is estimated that 35-200 kW |
| | | | power is required, which could be supplied by |
| | | | onsite installations or a mobile gas pr diesel |
| | | | powered generator |
| | | | Cooling system, e.g., water or electrical cooling. |
| | Inductor | 3 | Induction furnace in form of a coil with one or |
| | | | several windings. The coil takes shape from the |
| | | | liner cross section, which it should follow |
| | | | intimately to optimize energy transfer. |
| | | | Several components are not shown: |
| | | | Ventilation shielding allowing for a laminar air |
| | | | flow around the sample of sufficient strength to |
| | | | lower fume concentration below ATEX limit. |
| | | | Control system to control ventilation. |
| | | | Magnetic shielding lowering flux outside the |
| | | | furnace to zero |
| | | | Motors, gears and control system that allow liner |
| | | | to be moved forward and to control speed to a |
| | | | preprogrammed profile. |
| | | | A focusing system that position the liner for |
| | | | passing through the furnace. Adaptable to |
| | | | different liner geometries. |
| | Option | Not | A smaller handheld inductor focusing the magnetic |
| | | shown | could be used to heat areas of the accessible |
| | | | surface. |
| | Ventilation | 4 | A centrifugal fan capable of blowing off-gasses |
| | | | and fumes away from the heated areas to avoid |
| | | | ignition. |
| | Filtering | 5 | The vent airstream must be sucked into a hood with |
| | | | a filter for removing char, VOC, and other dust. |
| Conveyor | Conveyor 1 | 6 | Automatic conveyor system transporting the liner |
| | Conveyor 2 | 7 | through the induction furnace (inductor) |
| | Option | Not | Rather than moving the liner through a steady |
| | | shown | inductor, the inductor may be moved along a steady |
| | | | liner together with ventilation and filtering. |
| Secondary | Shaker | 8 | One embodiment of a secondary mechanical separation |
| mechanical | | | machinery is a shaker machinery capable of shaking |
| separation | | | metal and rubber apart after their bonding is removed |
| | | | by induction heating. |
| | Option | Not | A crane or similar with a mechanical gripper or a |
| | | shown | lifting magnet that can be used to rip metal and |
| | | | rubber apart. |
| | Vibration | 9 | Char coal dust and small rubber particles released |
| | filter | | when the interfaces between steel and rubber are |
| | | | revealed during the secondary mechanical separation |
| | | | is removed and collected. |
| | Unloading | 10 | A crane or similar to pick metal parts and rubber |
| | | | parts an load them either directly on a truck or into |
| | | | a storage. |

FIG. 2 is a schematic representation of an embodiment of a separation station of the apparatus according to the present invention, for removing steel parts from the rubber matrix after debonding by induction heating, consisting of:
a. A table or similar (11) of approximate size 1 m×1 m and adjusted in height to the conveyor receiving the liner after induction heating. The table being fixated to the ground.
b. A switchable or electromagnetic lifter (12) fixated to the table.
c. A brace or other mechanical fastener that can hold the rubber or steel parts fixed to the table (not shown).
d. A crane or lifter that can be equipped with a magnetic lifting head or a grabber to hold on the abrasive resistant steel parts and the rubber matrix.

FIG. 3 is a schematic representation of an embodiment of a ventilation cover (13) of the apparatus according to the present invention, for creating a laminar flows around the inductor to blow an suck away fumes, off gasses, and dust.

FIG. 4 is a schematic representation of an embodiment of a cover (13) with top hood (14) and sketch of air flows inside the ventilation cover. The inlet flow may be provided by a ventilator. The outlet suction by another ventilator.

FIG. 5 is a schematic representation of an embodiment of circumventing inductor coil (15) with three windings and 100 mm long. Where length is the long direction of the liner passing through the coil. The inductor coil is shaped after the cross section of the liner orthogonal to the long direction.

FIG. 6 is a schematic representation of an embodiment of a pancake inductor coil (16) with three windings and 100 mm long. The width of the coil covers the full width of the baseplate. The coil heats the baseplate from below.

FIG. 7 is a schematic representation of an embodiment of steel parts (17) and rubber matrix (18) in a medium sized composite sag mill liner (19).

The liner (19) consists of steel parts (17) molded into a rubber matrix (18). The bonding between steel (17) and rubber (18) holds the structure together.

Liner dimensions: 2020 mm×931 mm×height
Height from underneath baseplate center: 250 mm at lifting hook.
Height from underneath baseplate center: 235 mm at top of ASTM A532 parts.

Weights and materials from bottom and up:
Baseplate ASTM A36 steel 122 kg×1
Rubber matrix 113.1 kg×1
AR 550 HB steel 41.2 kg×4
AR 600 HB steel 116.9 kg×2 incl. hooks
ASTM A532, IIB 73.7 kg×8

FIG. 8 is a schematic representation of exploded view of liner parts. All are steel parts except rubber matrix. From the bottom and up: Baseplate (20); molded rubber matrix (18); very hard abrasion resistant steel parts (17); abrasion resistant steel lifters (21).

FIG. 9 is a schematic representation of an embodiment of liner steel parts only. Rubber matrix hidden to emphasize surfaces heated by induction heating.

### DETAILED DESCRIPTION

The following clearly and completely describes the technical solutions in the embodiments of the present invention with reference to the accompanying drawings.

The present invention provides for an optimized method for separating metal reinforcement from rubber-metal composite specimen, in particular the separation of metal reinforcement from used or worn-out mill liner. The essence of the invention lies in the fact that the respective composite element first gradually passes through its entire length or circumference continuously through a high frequency electromagnetic field driven by a power supply with an output power of 35 to 200 kW. This results in induction heating of the metal reinforcement over the entire width of the composite part and pyrolysis of the thin rubber layer bonding the metal surface with rubber, leading to the primary release of the metal reinforcement from the rubber matrix. This is followed by separation of metal part from the rubber portion of the composite material by means of secondary mechanical separation to draw the metal component out of the composite mill liner.

The composite part to be recycled can advantageously be pre-adjusted by cutting into relatively smaller pieces.

In the method and apparatus according to the present invention, the induction field penetrates only into a skin layer of conductive and magnetic materials. Heat is quickly transferred to the steel surface and heats it above 300° C. It causes pyrolysis of a thin rubber layer in contact with the steel, hence creating a permanent slip between rubber and steel. Any primer or binder adhering rubber to steel is removed in the process.

The induction heating method and apparatus according to the present invention is the best suited technology for a mobile recycling solution for composite liners for many reasons:
The operations required to recycle a liner is relatively simple and the materials are little deteriorated during the heating operations.
Temperature and heating times can be controlled to ranges where the steel parts are little affected.
The amount of rubber that needs to be pyrolyzed can be controlled to a minimum without affecting the properties of the remaining rubber.
Some parts of the liner, e.g., the baseplate, may be refurbished and used again.

The device for carrying out the method according to the invention primarily consists of a loading and extraction system, an induction heating system, and a secondary mechanical separation system. The loading and extraction system consist of conveyors, trolleys, pulleys, or sledges that can pass the composite specimen through an area where it is heated by the induction heating system. Cranes, lifters, or other devices for handling the composite is also part of the loading and extraction system. The induction system consists of a power supply and one or more inductors, a matching unit, and a cooling unit. The induction system is provided with a ventilation and filtering system for removing fumes, dust, and off gasses during heating. The secondary mechanical separation system is provided with machines or machinery for removing steel parts of the composite from rubber parts.

The apparatus according to the present invention in certain embodiments can be made into a mobile unit to be deployed at or near to a mining site, which includes any of the following components in addition to the primary induction system and separator system:
a container to hold all instrumentation and machinery, parts of which may be deployed in the open air at the mining site;
Power supply for the containerized parts of the machinery;
ventilation options build into the container The composite specimen is passed through an area where inductors heats metal parts of the composite.

The composite specimen is oriented such that it is passed through the heating area along its length dimension. The length dimension is characterized by a uniform or approximately uniform cross section. The approximately uniform cross section may not be orthogonal to the length direction.

The inductors consist of one or more coils oriented such that heating induction coil extending over the full liner width. The number of turns and its length is a matter of design optimization. Its geometry and eventual housing can be based on models including flux line optimization using permanent magnets of ferrite composites to direct the magnetic field lines evenly into the liner structure.

Ventilation to reduce fume concentrations below ignition and explosion limits are also installed into the apparatus to avoid flames.

A secondary process for separation of the metal part from the rubber component of the mill liner subsequent to induction heating includes shaking of the liner till steel and rubber separates and a subsequent sorting of the parts, e.g., sieving or lifting out steel parts with a lifting magnet.

In addition to the secondary process, a washing or filtering process to remove charcoal dust. Part of this operation may take place at the rubber recycling facility.

Logistics for packaging and transporting the parts to recycling or refurbishment is also part of this disclosure.

In an embodiment of the invention, the inductor thread preferably has ferrite segments, each 10 to 50 mm wide, located in its edge regions.

In a further embodiment, the separator inductor is preferably equipped with a cooling system, the separator as a whole is furthermore equipped with a pneumatic control system and/or limit switches.

The method and apparatus according to the invention optimize known principally similar methods in the following points:
1) the effect of the high-frequency electromagnetic field on the composite part is optimized: the high-frequency electromagnetic field is driven by a power supply with an output power of 35 to 200 kW. Frequency and power are optimized to raise the temperature of the steel parts surface to a temperature of 500° C. to 550° C. within few minutes. The temperature is optimized both to provide a rapid pyrolysis of the steel-rubber interface and at the same time, not to degrade the steels properties, e.g., hardness and micro structure. It is demonstrated that rubber pyrolyzes between 300° C. and 500° C. whereas excess char burns in oxygen between 450° C. and 500° C. Commonly, rubber is pyrolized at lower temperatures from 300° C. to 400° C. Higher temperature allows a precise control of how thick a rubber layer that is pyrolized at the surface at higher degradation speeds. The choice of an operating temperature range from 500° C. to 550° C. is considered optimum for recycling mill liners with respect to time, temperature, energy consumption and preservation of materials properties.
2) The inducer designed according to the present invention which is in the form of a coil with one or more windings that takes the shape from the mill liner cross-section for optimal energy transfer is identified to be efficient in pyrolyzing a thin rubber layer in contact with the metal surface and there is no overheating of the composite part in the middle of the inductor thread and no reheating at the edges.
3) For heating the baseplate of the composite liner, a flat pancake coil is more efficient. The coil should extend over the full width of the liner's baseplate. It may have few windings, e.g., three windings, and a narrow length, e.g., 100 mm. Length is the extension of the coil in the liner's length direction. The induction heating system should allow for easy switching between coils.

The present invention will be described more specifically on the basis of examples, although the present invention is in no way limited to or by these examples.

### EXAMPLE

### Example 1: Demonstrating Separation of Natural Rubber and Magnetic Steel Components; Temperatures Used to Pyrolize the Rubber; and the Thickness of Pyrolized Rubber Layer Required to Debond Steel from Rubber

### 1.1 Method and Instrumentation

Induction heating was performed in an inhouse installation with a water-cooled induction heat station and a power supply from UltraFlex Power Technologies. The equipment is built into a ventilated cabinet. Additional suction to remove fumes and gasses during the heating was placed immediately above the sample. An inductor coil of length 80 mm with 6 windings was used.

Induction Heating System from UltraFlex Power Technologies:
Power supply: UltraFlex UPT-S2, rated current 12 A rms, rated power 2.5 kW, 50-250 kHz
Induction heating unit: UltraFlex HS-4, water cooled
Inductor: In-house winded from 6×1 mm cobber tubing insulated with a PTFE heat shrink. Length 80 mm, 6 windings, internal diameter 80 mm.

Induction heating were performed at a frequency of 63 kHz and with 24×current transformation allowing up to 240 A in the inductor. The load match between sample and inductor was optimized to allow the power supply to operate near to its maximum performance by tuning the parameters to heating of bare steel rods. The instrument does not allow for read-out of active and reactive power, but an ABB electricity meter is coupled to the power supply to measure apparent power.

### Electricity Meter:

ABB B21 112-100

### Data Acquisition:

Labview programme and instrumentation
Temperature sensors
K-type thermocouple from RS-Components

### Thermo Gravimetric Analysis (TGA):

TGA/SDTA851 e from Mettler-Toledo

A TGA analysis was performed on a piece of vulcanized rubber to follow the degradation during heating.

Initial measurements were performed on bare steel rods to adjust instrument parameters to match loads between the supply, the inductor, and the sample. Adjustable parameters are frequency and heating unit transformer's turn ratio (24×).

One set of experiments were performed using four samples with EN 1.4057 cores and heating times varying between 30 seconds and 75 seconds. After heating, cores were removed, the inside of the hole in the rubber cylinder were brushed with a steel brush to remove all lose charcoal. Charcoal was collected and weighed. From the weight of the sample and parts before and after heating, the mass of reacted rubber was determined as the sum of charcoal and mass lost as fumes and gasses. A temperature sensor was placed along the core by pressing a 40 mm long syringe needle tip into the rubber alongside the steel core. The temperature sensor was inserted in the needle tip.

A second set of experiments were performed on samples with EN 1.4021 steel cores and with three sensors embedded in the sample: a 5 mm deep hole was drilled midway along the steel core and a sensor was inserted. A second sensor was placed parallel to the steel rod opposite to the first sensor. Both were fixated with a wire. A single winding of 3 mm thick rubber compound was wrapped around the core, and the last sensor was placed parallel to the two others.

### 1.2 Samples

Reference experiments were conducted by heating bare steel cores of both types: EN 1.4021 and EN 1.4057

Magnetic properties read from the documents referenced as additional material are:
1. Stainless steel rod EN 1.4021 QT700-martensitic, HB 220, Curie temp. 650-700° C.
2. Steel rod EN 1.4057 QT800-martensitic, HB 290, curie temperature 700-730° C.

The range of stainless steel with permanent magnetic properties in the form of rods are scarce. We selected two martensitic type stainless steels with different hardness, strength, and composition. The magnetic permeability of the low carbon type steels like ASTM A36 used in liners baseplate are typical higher than for the high chromium types used here.

Samples with EN-1.4057 cores: 4 samples with one temperature sensor, lengths 80-95 mm, core weight 47-56 g.

Samples with EN-1.4021 cores: 2 samples with three temperature sensors, length 80-90 mm.

In addition, undocumented tests were conducted for both types to test induction heating parameters.

### 1.3 Results

Several heating experiments were performed to demonstrate delamination of steel and rubber by pyrolyzing a thin interphase layer of rubber. While heating to 500° C. and above the samples developed strong fumes and degassing in the interphase layer. The off gasses must be removed by strong ventilation to avoid burnable atmospheres. In the experiment a point suction was added just above the sample. After heating and after removing the steel core, part of the interphase layer that charred to fine carbon particles was exposed and spread as dust. The debonding is permanent and a secondary operation is needed to remove the metal from the rubber. Huge forces are needed to press the steel core out of the rubber before heating and in the present experiments, the steel core can be pressed out by hand after heating.

### Operating Temperature Range: 500° C.-550° C. Determined by TGA

TGA of the rubber determined the temperature range needed to pyrolyze and char the interphase between rubber and steel. It is demonstrated that rubber pyrolyzes between 300° C. and 500° C. whereas excess char burns in oxygen between 450° C. and 500° C.

Hence, we conclude that an operating temperature of 500° C. is sufficient but it is beneficial to work with an adequate buffer of 50° C. such that induction heating processes should target an operating temperature range from 500° C. to 550° C.

### 1.4 Measurement of Reacted Rubber

Four samples were heated for different times and the amount of rubber removed as either fumes and gasses or charcoal was measured. The important result is that induction heating is a process that can be precisely controlled. For all heating times, the steel core could be pressed out from the rubber core with a light pressure after heating. The smallest reacted layer around the steel core corresponded to 1 g of rubber or a layer thickness 0.3 mm-0.4 mm.

### Example 2: Describing the Sequence of Induction Heating and Mechanical Separation Operations Needed to Separate Steel Part from the Rubber Matrix in a Liner Having a Baseplate and Several Abrasion Resistant Steel Parts Bonded by a Rubber Matrix

### 2.1 Method and Instrumentation

The following example deals with the sequence of operations required to separate the rubber and steel parts of a composite liner. FIGS. 7, 8, and 9 shows the buildup of a typical liner. The example pertains to the separation using a recycling solution consisting of a liner loading system, an induction heating system, a liner extraction system and a mechanical separation system. The liner loading and separation system consists of two motorized conveyors that are positioned with a gab of one third of the liner length between the two. Inductors in form of a coils connected to the induction heating system span the full width of the liner and is placed in the gab, such that the liner can be passed through the inductor or over the inductor. Two inductors are further described below. The mechanical separation system consists of a table with a whole in. Under the whole an electromagnetic lifting head or a switchable permanent magnetic lifter is fixated. The table and lifting head being either heavier than the liner of fixated in the ground and able to withstand a normal lifting force higher than 10,000 N. The mechanical separation system also has a crane or other lifter with a grabber or a magnetic lifting head.

One inductor is a circumventing inductor where the liner is passed through. The inductor could also be swept along the liner; this being a less preferred solution, however. The other inductor is flat in a so-called “pancake” design. Heating of the steel parts surfaces is induced when the steel parts pass through or over the inductor. A heat flux of up to 1,000 kW/m2 induced in the so-called skin layer of the surface is sufficient to reach temperatures of 500° C. to 550° C. in minutes. This time and temperature is sufficient to debond rubber and steel parts by pyrolyzing a 0.1 to 5 mm thick layer at the rubber-steel interface. However, the rubber-steel interfaces lie between the baseplate of the liner and the abrasive resistant steel blocks at the top of the liner. As a result, the baseplate will screen the magnetic field at the inner surfaces of the top steel parts and vice versa when passed through a circumventing inductor. Hence the solution is to separate the metal parts in two passes. The liner is placed with the baseplate facing down on the delivering conveyor passing the liner through the inductor. The inductor is placed midway between two conveyors—the delivering and the receiving conveyor. The gab between the two conveyors must be sufficiently small to avoid the liner tipping when passing the gab. A gab of one third of the liner length or approximately 600 mm is appropriate.

The sequence of two passes is:
a. In the first pass, the baseplate is heated and subsequently removed. Heating may take place by using a pancake inductor underneath the base plate, see FIG. 6. Alternatively, the circumventing inductor, FIG. 5, can also be used, but is less efficient because the top metal parts are heated simultaneously without heating to a temperature where pyrolysis occurs.
   After the liner has been passed to the receiving conveyor it is passed to a station—see FIG. 2—with a magnetic lifting head fixed under the baseplate, the lifting head being either an electromagnet or a switchable permanent magnet. When the magnetic field is turned on, the baseplate is locked to the conveyor. Now a crane using the lifting hooks can lift the rubber matrix and the top metal parts up, separating the baseplate from the rubber matrix. Small areas of attachment may exist after the heating and are simply mechanically broken in the lifting process.
b. The magnetic field is turned off and the baseplate is passed further down the line and removed. The upper parts of the liner are lowered onto the conveyor again. The inductor is changed to the circumventing inductor, FIG. 5, and the parts are passed reversely through the induction field from the receiving to the delivering conveyor. After heating the parts are passed back to the receiving conveyor and the magnetic fixation area. If the area is equipped with several electromagnets that can lock different parts at a time or by a brace that lock the rubber matrix mechanically, the other abrasive resistant steel parts may be removed by a crane and by the end, e.g., only the two parts with the lifting hooks remain. They can finally be removed by mechanically locking the rubber and lift the steel parts away.

Overall, the mass of the target liner (see appendix) is 1240 kg and the rubber matrix weighs 113 kg. The maximum weight lifted could be 4×ASTM A532 segments for a total of 300 kg. The bolt fixtures in the baseplate are difficult to heat, hence rubber may still be vulcanized to those after heating. A force up to 10,000 N could be needed to break that interface, hence cranes and locking devices must be able to hold 1 ton.

### 3.1 Method and Instrumentation

Demonstrating the superiority of using a circumventing inductor coil to debond the abrasive steel/rubber interface by electrodynamic and heat dissipation modeling.

A simulation of the induction heating of an actual liner was performed using COMSOL Multiphysics® with the AC/DC module allowing for a combining induction heating simulation with heat dissipation simulations in the steel parts.

Further, based on surface heat fluxes calculated using COMSOL, heat dissipation calculation using Solidworks Premium 2022 was performed mimicking a transfer of the heating zone along the liner—or a pass of the liner over or through the heating zone.

The purpose of the simulations was to show that reasonable inductor designs and induction heating parameters allowed for heating the steel/rubber interface to the temperatures required for pyrolysis in short times. Furthermore, to demonstrate how control of heating power, conveyor speed, and inductor geometry allows for even heating of most interfaces. Furthermore, to demonstrate that first heating and removing the baseplate in one pass and subsequently heating abrasive resistant steel parts in a second pass is both energy and time efficient and the best way to secure that parts are not overheated.

The induction heating simulation was performed using a constant current of 1000 A in the coil and a power of 35-200 kW. The inductor was modelled as three windings extending 100 mm in the length direction of the liner and circumventing the cross-sectional profile of the inductor. In another experiment, a nearly flat inductor with one winding was placed underneath the baseplate. The inductor also extended 100 mm in the length direction and covering the full width of the baseplate. The shape of the inductor followed the cross-sectional shape of the baseplate such that its distance to the plate was 30 mm over the full width. It was also compared to a pancake coil covering the full baseplate.

The example mimics the heating operation performed in two passes of the liner: first pass debonds the baseplate/rubber interface and the baseplate is mechanical removed after this first pass; second pass debonds the abrasive resistant steel parts/rubber interface.

### 3.2 Samples

Only the liners major steel parts were considered in the calculation. The rubber matrix was excluded and only heat conduction between touching parts were included in the heat dissipation calculation.

### 3.3 Results

Simulated system parameters for a circumventing coil:
Inductance: 10 pH
Heat flux: 200-400 kW/m² on steel surfaces
Heating power: 100 kW
Coil power: 160 kW
Frequency: 100 kHz
Current: 1000 A
Voltage: 5500 V

Heating the base plate with either a pancake coil that cover either the full baseplate or a 100 mm long section demonstrates that heating the baseplate in 20 minutes with an average power of 25 kW raises the temperature at the inwards side (facing the rubber matrix) raises the temperature to 500° C. Hence debonding the baseplate/rubber interface can be undertaken in even shorter time when power is raised. Time, power consumption, and efficiency are equal for a full covering coil and for a coil covering only a 100 mm section that the liner is passed over. For the latter, heat convection of the non-heated section means that average temperature after heating is reduced. The challenging heating operation is the heating of the steel/rubber interface of the abrasive resistant steel parts after the baseplate is removed.

Heating and dissipation modelling for the second pass: The liner model was simplified to contain only abrasive resistant steel parts. The rubber matrix and the baseplate were neglected. The model was sectioned into 100 mm sections along the liner's length direction in Solidworks. A heat flux was applied to surfaces within one section at a time. Heat conduction along coherent steel parts was allowed for as well as convection from surfaces exposed to air. The exposed surfaces in the section being heated was modelled with a convection coefficient of 100 W/m2/K to mimic a strong laminar airflow along the surface. The remainder of the model's exposed surfaces was modelled with a convection coefficient of 20 W/m2/K mimicking a constant ventilation. Ambient temperature is fixed at 25° C. In the following, we distinguish between outward surfaces and inward surfaces. Outward surfaces being surfaces exposed to air or are at the edges of the model, where they are covered by a thin layer of rubber. Inward surfaces are facing the rubber matrix and it is their interface to the rubber matrix that needs to be debonded during induction heating. A closer examination of the model shows that there are shallow and deep inward surfaces, shallow meaning closer to the baseplate than deep surfaces.

Based on results from the electrodynamic heating simulation in COMSOL, we assign heat fluxes of 300,000 W/m2 to outside and shallow surfaces and 200,000 W/m2 to deep surfaces. Each section is heated for 150 s under these conditions. Surfaces facing the gab between steel parts are not heated. This situation mimic heating with circumventing coil and it only looks at one metal part and not the full liner cross section.

Overall, heating a section of the model for 150 s raise its surface temperature to above 450° C. The steel part with the most complex geometry made from ASTM A532 steel is sectioned into five parts of 100 mm and heating each of these in 150 s consumes 2.2 MJ of electrical energy. Hence heating 5 sections consecutively consumes 11 MJ in 750 s corresponding to an average power of 17 kW. After the heating, an equilibration of all temperature differences results in an average temperature of 344° C.

In comparison, a simulation, where the full non-sectioned steel part is heated solely from the outward surfaces using a pancake coil shaped to the surface profile requires 600 s to heat the inward surfaces to above 450° C. The temperature of the heated outwards surfaces is capped at 750° C. to mimic the efficiency drop in inductive energy transfer, when the steel passes its curie temperature. In total 23 MJ is consumed corresponding to an average power of 38 kW with an equilibrated temperature of 689° C.

The simulation demonstrates that heating the inward surfaces with a circumventing coil is twice as efficient as heating the outward surfaces with a pancake coil and waiting for heat to dissipate through the structure. Equally important is it that the average temperature of the steel in the later case is all to high. In the former case, the average temperature of 344° C. means that it is possible to handle the steel parts with a manual manipulator, whereas 689° C. means that automation and additional safety measures must be taken.

The conversion efficiency of coil power to heating power is however better for the pancake coil. than for the circumventing coil. Coil power is the power delivered from the induction heating power supply, hence proportional to the consumed electrical power.

For a pancake coil closely following the liner outwards surfaces, a conversion efficiency of 90% is estimated. For a circumventing coil shaped after the liner cross section, a conversion efficiency of 62.5% is estimated.

For the circumventing coil, a coil power of 160 kW is required to heat the inwards and outwards surfaces with a heat flux of 200-300 kW/m2. Using the same coil power, a heating power of 144 kW is available for the case of heating the outwards surfaces with a pancake coil using an efficiency of 90%.

The shape of a worn-out liner differs from liner to liner; hence the real efficiency of a pancake coil may easily fall below the 90%. If so, the time for heating from the liner from the outward surfaces increases.

The simulation shows that heating the full cross section with a circumventing coil consumes 4 times more electrical energy than heating the single ASTM A532 steel part. With 90% efficiency for a pancake coil, heating times for the two situations are equal at the same coil power. However, the circumventing coil is little influenced by changes to worn-out liner geometry, whereas the pancake coil's efficiency is strongly influenced. Hence real heating times may become longer for the pancake coil.

In conclusion, it is found that comparing heating with a circumventing coil to heating the outward surfaces with a pancake coil demonstrates these advantages: it is at least 50% more energy efficient to heat with a circumventing coil; the temperatures are more homogenously distributed over the metal/rubber interface; the metal parts' temperature after heating is significantly reduced; and that heating times and hence cycle times are a priory equal for the two heating models, but the heating time is relatively independent of liner geometry for the circumventing coil and may increase considerably for a pancake coil the more the worn-out liner shape differs from the original shape.

### Example 4: Demonstration the Rate with which Natural Rubber Pyrolyze and the Degree of Conversion that is Reach in the Temperature Range from 300° C. To 550° C. The Purpose is to Show that Heating the Metal Rubber Interface to a Temperature Between 500° C. To 550° C. Ensures Full Debonding in Short Time and to Differentiate Our Method from Methods Debonding at Lower Temperatures

### 4.1 Method and Instrumentation

A TGA analysis was performed on a piece of vulcanized rubber to follow the degradation during heating at constant temperature using a TGA/SDTA851e from Mettler-Toledo. The purpose is to determine the speed of pyrolysis in N₂ atmosphere at temperatures in the range 300° C. to 550° C.

When natural rubber pyrolyze, it loose up to 64% of its weight due to off-gassing and loss of volatile liquids. The remains are carbon black like compounds that burns fully away in an oxygen atmosphere as demonstrated by TGA as described in example 1. Debonding between rubber and steel may be obtained at degrees of pyrolysis higher than 75% corresponding to a typical bond percolation threshold. Also, from example 1, it is estimated that pyrolyzing a 1 mm thick rubber layer at the rubber/steel interface is sufficient to debond rubber from steel.

The results are also used to demonstrate the requirements to the induction heating system and the speed that the liner can be passed through the induction field with. Three speeds are important for this analysis: the speed with which more than 75% of the rubber in a 1 mm slab is pyrolized; the speed at which heat dissipates from the steel surface into the rubber; and finally, the speed at which the induction system can heat the steel interface.

TGA was performed with the following parameters:
Sample inserted in oven at 200° C. and heated to the relevant temperature over 1 minute.
N₂ gas flow 50 ml/min.
In a series of experiments, temperatures are kept constant at 300° C. for 60 min; at 350° C. for 60 min; at 450° C. for 20 min; at 500° C. for 10 min; and at 550° C. for 10 min.

A previous standard TGA showed that up to 64% of rubber by weight pyrolyze to gas/volatile liquids in N₂.

### 4.2 Samples

Cylindrical pieces of vulcanized rubber previously described was cut to samples of diameter 4 mm and a weight of 15-30 mg.

### 4.3 Results

The weight loss within one minute from the sample reached the prescribed temperature was measured and compared to the maximum weight loss of 64% in N2 atmosphere. The results can be interpretated as the fraction of a rubber sample pyrolyzed within one minute at a given temperature. The experiments showed:
3% is pyrolized at 300° C. within a minute;
18% is pyrolized at 350° C. within a minute;
65% is pyrolized at 450° C. within a minute;
78% is pyrolized at 500° C. within a minute; and
95% is pyrolized at 550° C. within a minute.

The maximum conversion at a given temperature is reached at different times:
16% is pyrolized at 300° C. within 60 minutes;
60% is pyrolized at 350° C. within 60 minutes;
100% is pyrolized at 450° C. within 18 minutes;
100% is pyrolized at 500° C. within 5 minutes; and
100% is pyrolized at 550° C. within 3 minutes.

From this study, it can be concluded that the higher temperatures are required to reach an acceptable pyrolysis speed. Choosing a high temperature of 500° C. to 550° C. distinguish the present method from methods, where pyrolysis occurs at lower temperatures from 300° C. to 350° C. The speed with which an interface layer of rubber at the rubber/steel interface is pyrolyzed also depends on the heat dissipation into the rubber. Using Density=8000 kg m-3; Thermal conductivity=50 W m-1 K-1; Specific Heat=500 J kg-1 K-1, heat is dissipated 1 mm into rubber within 3.5 seconds. Hence pyrolysis is the slower process that determines the rate at which the interface pyrolyze and a temperature range from 500° C. to 550° C. allows for nearly full pyrolysis of a 1 mm layer with a minute.

If an inductor has a length of 100 mm in the liner's long direction, the liner having a total length of 2000 mm, it means that heating each 100 mm segment for a minute can be obtained within 20 minutes and pyrolyzing a 1 mm thick layer at the interface. An acceptable time for the rubber steel debonding even if more passes of the liner through the induction field are required.

The induction heating system must be able supply sufficient power to reach temperatures of 500° C. to 550° C. in less than one minute.

If the induction heating system is slower, it will determine the speed with which the liner may be passed through the induction field.

We claim:

1. A method for separation of metal reinforcement from rubber-metal composite of used mill liners, comprising:
a) radiating the metal components embedded in the mill liner by gradually passing the composite part, by its length or circumference, more than one time through a high-frequency induction field and drawing different metal components out of the composite mill liner after each pass, wherein the induction filed is supplied by a circumventing inductor coil shaped to follow to the geometry of the mill liner's cross section to be recycled and supplies up to 1,000 kW/m² to parts of the metal surface for induction heating of the metal reinforcement over the entire width of the composite material, sufficient to pyrolyze a thin rubber layer in contact with the metal surface, thereby releasing the metal from the rubber matrix;
b) separating the metal part from the rubber portion of the composite material involving a secondary mechanical separation to draw the metal component out of the composite mill liner.

2. The method according to claim 1, wherein the circumventing inductor coil comprises protrusions at sharp corners to reduce uneven heating.

3. The method according to any one of the preceding claims, further comprising, prior to step a) radiating the base metal part of the mill liner by passing the composite parts by its length through a high-frequency induction filed supplied by a pancake inductor coil, for drawing the metal base plate out of the composition mill liner prior to removing the embedded metal parts.

4. The method according to claim 3, wherein the width of the coil covers the full width of the baseplate and heats the baseplate from below.

5. The method according to any of the preceding claims, wherein radiating the metal component embedded in the mill liner heats the metal surface to a temperature between 450° C. to 650° C., preferably between 500° C. to 600° C., most preferably between 500° C. to 550° C., whereby a thin layer of primer, binder and rubber on the steel surface is pyrolyzed into gasses, fumes and solid carbon-rich compounds such as coke, charcoal and/or graphite.

6. The method according to any of the preceding claims, further comprising controlling the speed of induction heating by:
controlling the speed at which the composite mill liner is fed through the induction field;
changing the power of the induction field such that different parts of the metal components are heated at different rates while passing through the induction field;
adjusting the geometry of the inductor coil to focus the induction field at certain parts of the metal components while they passe through the induction field;
using external magnetic materials to focus the induction field on certain parts of the metal components while they passe through the induction field;
any combination of said methods to control the speed of heating;
in order to minimize degradation of both rubber and metal to maintain optimal properties for recycling of materials or refurbishment of metal components.

7. The method according to any of the preceding claims, wherein the step of separating the metal component from the rubber portion involving secondary mechanical separation includes vibrating, shaking, milling, dropping, hammering, pushing or pulling operations.

8. The method according to any of the preceding claims, further comprising sorting rubber and metal components after induction heating by:
cutting, shredding, and filtering operations;
gravitational separation;
magnetic separation;
any combination of said methods of sorting rubber and metal.

9. The method according to any of the preceding claims, further comprising avoiding fumes, off-gasses and coal particles generated during induction heating by providing:
a ventilation in form of a suction above the heating zone;
an air blower, e.g. a fan or a centrifugal blower;
a shielding or a cabinet directing an air stream;
a non-oxidizing gas stream to displace oxygen in the heating zone; and/or
a filtering unit filtering particles from the exhaustion air or gas stream;
such that fumes, off-gasses and coal particles are removed from the heating zone.

10. The method according to any of the preceding claims, further comprising extinguishing fire caused by fumes, off-gasses, coal particles generated during induction heating, or by the rubber parts themselves, by using a manual or semi-automatic or automatic fire suppression system above the heating zone and optionally extending partly or fully over the liner's path such that fires that persists on either side of the heating zone may still be extinguished.

11. The method according to claim 10, wherein the manual, semi-automatic, or automatic fire suppression system consists of:
a carbon dioxide or other oxygen displacement gas extinguishing system; and/or
a water mist extinguishing system.

12. The method according to claim 1, wherein the metal component of the composite mill liner has magnetic or electric properties.

13. The method according to claim 1, further comprising controlling magnetic flux penetration into the composite part by the use of a magnetic shielding, permanent magnets or soft magnetic material comprising magnetic particles such as ferrite particles around the inductor, such that it most efficiently separates rubber from steel components.

14. An apparatus for separation of metal reinforcement from rubber-metal composite of used mill liners and a mill liner positioned within the apparatus for separation of metal reinforcement and rubber-metal composite, wherein it comprises:
a) an induction system comprising a circumventing inductor coil shaped to follow to the geometry of the mill liner's cross-section, positioned within the apparatus, and supplying up to 1,000 kW/m² on parts of the metal surface for induction heating of the metal reinforcement over the entire width of the composite material, sufficient to pyrolyze a thin rubber layer in contact with the metal surface and efficiently separate the metal parts from the composite mill liner;
b) an automatic conveyor system for transporting the mill liner through the inductor; and
c) a secondary mechanical separation system for separating the metal part from the rubber portion of the composite mill liner.

15. The apparatus according to claim 14, wherein it further comprises
d) an induction heating generator, capable of outputting power of 35 to 200 kW, for induction heating of the metal reinforcement over the entire width of the composite material; and
e) a cooling system capable of cooling both power supply and the inductor with safety interlocks and differential pressure monitoring for automatic lockdown of the induction heating supply.

16. The apparatus according to claim 14, wherein the induction system further comprises:
i) ventilation system consisting of a ventilator and a shield allowing for an air flow of sufficient strength to flow around the section of the mill liner that is closest to the inductor to lower fume concentration below ATEX limits;
ii) magnetic shielding for lowering flux outside the induction system to zero;
iii) control unit for controlling the speed of the mill liner part moving through the induction system; and/or
iv) focusing system that positions the mill liner part for passing through the induction system, which is adaptable to different liner geometries.

17. The apparatus according to claim 16, wherein the ventilation system additionally comprises centrifugal fan capable of blowing off gasses and fumes away from the heated areas to avoid ignition.

18. The apparatus according to claim 16, wherein the ventilation system is capable of
removing off gasses, dust and fumes generated with a rate of 5-10 g/s, 10-25 g/s from the heated areas to avoid ignition;
securing an air exchange of 1000-30,000 m³/hour around the section of the mill liner closest to the inductor; and/or
achieving an energy transfer sufficient to raise the surface temperature of steel parts to between 500° C. to 550° C.

19. The apparatus according to claim 14, wherein the circumventing inductor coil of the induction system, which is shaped to follow the geometry of the composite liner's cross section, has protrusions at sharp corners to reduce uneven heating.

20. The apparatus according to claim 14, wherein the induction system additionally comprises a pancake inductor coil, for drawing the metal base plate out of the composite mill liner prior to removing the embedded metal parts.

21. The apparatus according to any of the preceding claims, wherein the inductor comprises a casing in the form of a metallic shield or any other form that withstands temperature from 300° C. to 650° C. and allows for controlling magnetic flux penetration into or outside the induction system.

22. The apparatus according to any of the preceding claims, wherein the inductor comprises a non-metallic casing with permanent magnets, high magnetic permeability parts, ferrite or other magnetic particles, distributed in or around the casing in order to control the magnetic flux penetration into or outside the induction system.

23. The apparatus according to claim 22, wherein said non-metallic casing is a high temperature resistant thermoplastic selected from one or more of PEEK, PSS, PSU, flour polymers, PBI, polyimide, polyamides, polyaramides or other high temperature resistant thermoplastics.

24. The apparatus according to claim 22, wherein said non-metallic casing is a high temperature resistant thermoset selected from one or more of silicones, modified-silicones, epoxy thermosets, polyurethanes or other high temperature resistant thermosets curable by any means including heat, light or chemical agents.

25. The apparatus according to claim 14, wherein the secondary mechanical separation system comprises,
cranes or grabbers capable of lifting or shaking metal and rubber parts apart subsequent to induction heating of the metal part;
a shaker machinery capable of shaking metal and rubber parts apart subsequent to induction heating of the metal part; and/or
vibration filter for filtering and colleting charcoal dust and small rubber particles released from the secondary mechanical separation.

26. A system comprising the apparatus according to any of claims 14 to 25 and a mill liner positioned within the apparatus for separation of metal reinforcement and rubber-metal composite.

27. A mobile recycling unit comprising the apparatus as defined in any of claims 14 to 25 contained in one or more container and deliverable to the site of requirement.

28. The mobile recycling unit as claimed in claim 27, wherein the unit is operable while installed partly or fully in the container.
